(19) United States
(12) Patent Application Publication
(10) Pub. No.: US 2024/0139817 A1
(43) Pub. Date: May 2, 2024

(54) SYSTEMS AND METHODS FOR BUILDING THREE-DIMENSIONAL OBJECTS IN A CYLINDRICAL COORDINATE SYSTEM USING POWDER-BASED ADDITIVE MANUFACTURING TECHNIQUES

(71) Applicant: BATTELLE SAVANNAH RIVER ALLIANCE, LLC, Aiken, SC (US)

(72) Inventor: YUEFENG LUO, NORTH AUGUSTA, SC (US)

(21) Appl. No.: 17/974,791

(22) Filed: Oct. 27, 2022

(51) Int. Cl. B22F 12/37; B22F 10/14; B22F 10/85; B22F 12/90; B29C 64/165; B29C 64/245; B29C 64/393; B33Y 10/00; B33Y 30/00; B33Y 50/02

(52) U.S. Cl. CPC B22F 12/37; B22F 10/14; B22F 10/85; B22F 12/90; B29C 64/165; B29C 64/245; B29C 64/393; B33Y 10/00; B33Y 30/00; B33Y 50/02

(57) ABSTRACT

In one aspect, a system for building three-dimensional objects includes a powder source containing a powder material and a cylindrically-shaped substrate rotatable about a rotational axis. The substrate is provided in operative association with the powder source such that rotation of the substrate relative to the powder source about the rotational axis results in a layer of powder material being deposited relative to at least a portion of an outer surface of the substrate. The system also includes a fusion/binder source configured to cause the powder material deposited relative to the substrate to be fused or adhered together, and a computing system configured to control an operation of the fusion/binder source as the substrate is rotated about the rotational axis to generate a three-dimensional object relative to the outer surface of the substrate.

### FEDERAL RESEARCH STATEMENT

This invention was made with Government support under Contract No. 893033210EM000080, awarded by the U.S. Department of Energy. The Government has certain rights in the invention.

### FIELD OF THE INVENTION

The present subject matter relates generally to building three-dimensional objects using additive manufacturing techniques and, more particularly, to systems and methods for building three-dimensional objects in a cylindrical coordinate system using powder-based additive manufacturing techniques.

### BACKGROUND OF THE INVENTION

Traditionally, additive manufacturing techniques typically utilize a Cartesian coordinate system when building a three-dimensional (3D) object. For instance, with 3D printing, material is printed or deposited in a layer across a horizontal plane (e.g., an x-y plane), with subsequent layers being built-up on top of each previous layer in respective horizontal planes spaced apart from one another by a given vertical incremental value (e.g., a z-increment). However, when building objects having certain shapes or structures, it may be desirable to build such objects using a cylindrical coordinate system as opposed to a Cartesian coordinate system. In this regard, attempts have been made to develop additive manufacturing systems that build 3D objects in a cylindrical coordinate system when using a nozzle or printhead to directly dispense materials onto an underlying substrate. However, to date, no systems have been developed that address the use of a cylindrical coordinate system in combination with powder-based additive manufacturing techniques, such as powder bed fusion or other similar powder-based techniques.

As such, there is a need for systems and methods for building three-dimensional objects in a cylindrical coordinate system using powder-based additive manufacturing techniques.

### BRIEF DESCRIPTION OF THE INVENTION

Aspects and advantages of the invention will be set forth in part in the following description, or may be obvious from the description, or may be learned through practice of the invention.

In one aspect, the present subject matter is directed to a system for building three-dimensional objects. The system includes a powder source containing a powder material and a cylindrically-shaped substrate rotatable about a rotational axis. The substrate is provided in operative association with the powder source such that rotation of the substrate relative to the powder source about the rotational axis results in a layer of powder material being deposited relative to at least a portion of an outer surface of the substrate. The system also includes a fusion/binder source configured to cause the powder material deposited relative to the substrate to be fused or adhered together, and a computing system configured to control an operation of the fusion/binder source as the substrate is rotated about the rotational axis to generate a three-dimensional object relative to the outer surface of the substrate.

In another aspect, the present subject matter is directed to a method for building three-dimensional objects. The method includes rotating a cylindrically-shaped substrate about a rotational axis relative to a powder source containing a powder material, depositing a layer of powder material relative to at least a portion of an outer surface of the substrate as the substrate is being rotated relative to the powder source, and controlling an operation of a fusion/binder source to selectively fuse or adhere the powder material deposited relative to the substrate together as the substrate is being rotated about the rotational axis such that a three-dimensional object is generated relative to the outer surface of the substrate.

In a further aspect, the present subject matter is directed to systems and/or methods for building three-dimensional objects in accordance with one or more of the embodiments described herein.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a partial cross-sectional view of one embodiment of various components configured for use within a system for building three-dimensional objects in accordance with aspects of the present subject matter;

FIG. 2 illustrates a zoomed-in view of a portion of the system components shown in FIG. 1, particularly illustrates a cylindrical substrate positioned relative to a power tank and an associated powder gate of the disclosed system;

FIG. 3 illustrates a side view of several of the system components shown in FIG. 1, particularly illustrating the cylindrical substrate extending axially relative to the powder tank and associated powder gate;

FIG. 4 illustrates a schematic view of one embodiment of a computing system configured for use within a system for building three-dimensional objects in accordance with aspects of the present subject matter; and

FIG. 5 illustrates a flow diagram of one embodiment of a method for building three-dimensional objects in accordance with aspects of the present subject matter.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

In general, the present subject matter is directed to systems and methods for building three-dimensional (3D) objects in a cylindrical coordinate system using a powder-based additive manufacturing technique. Specifically, a cylindrically-shaped substrate may be rotated relative to a powder source containing powder material such that a layer of powder material is deposited relative to at least a portion of an outer surface of the substrate. Additionally, as the substrate is being rotated, a fusion/binder source may be controlled to selectively fuse or adhere the powder material together to allow a 3D object to the built-up relative to the outer surface of the substrate according to a computer-aided design (CAD) model or similar computer model. For instance, as will be described below, the 3D object may, in several embodiments, be built-up radially in layers relative to the outer surface of the substrate.

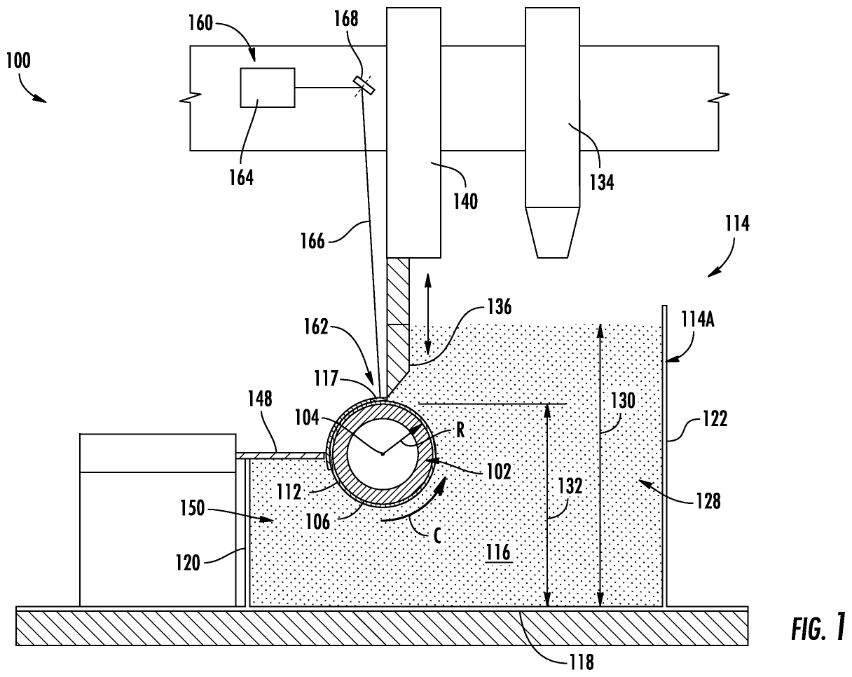

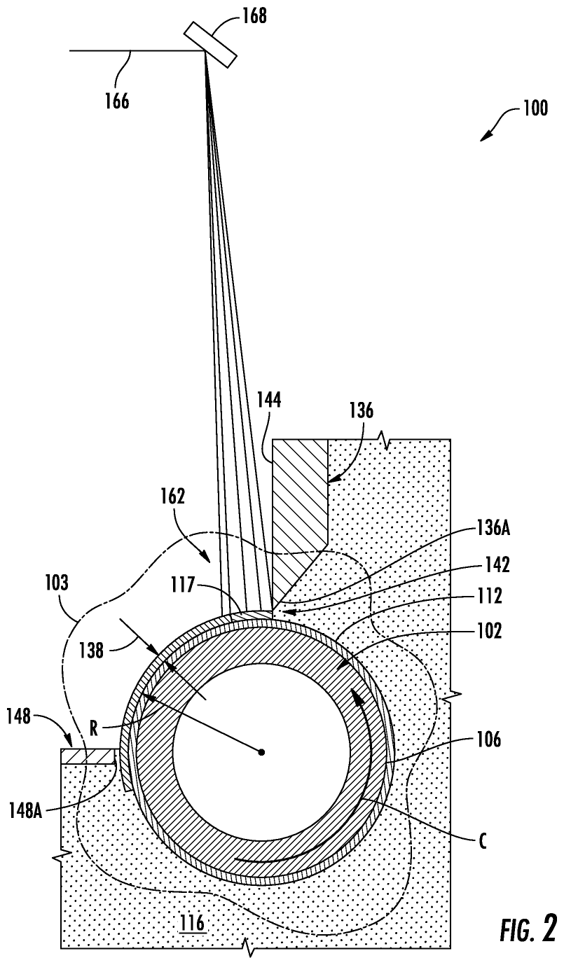

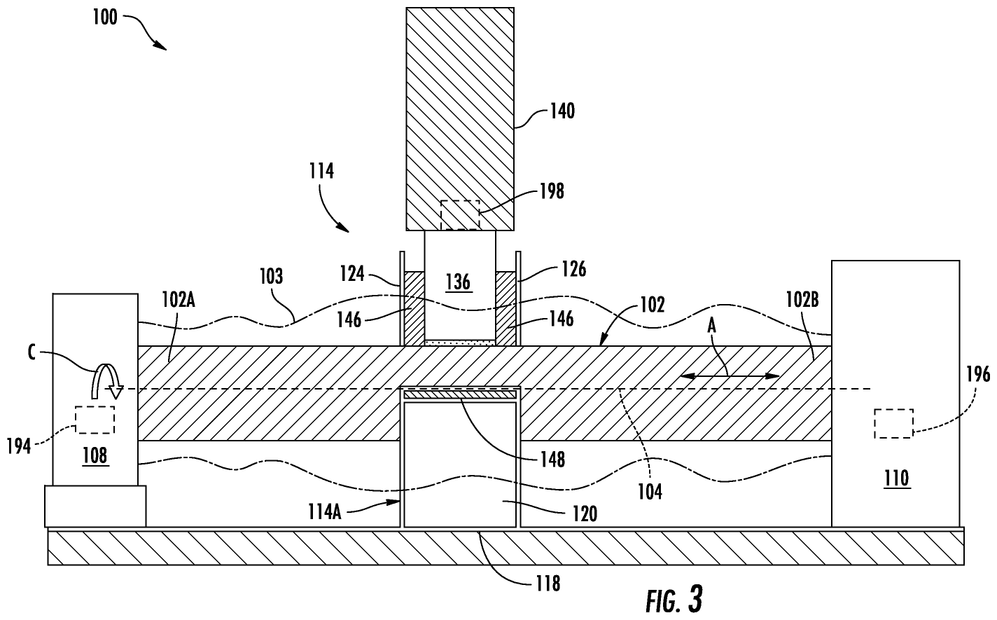

Referring now to FIGS. 1-3, several views of one embodiment of a system 100 for building a three-dimensional object in a cylindrical coordinate system using a powder-based additive manufacturing technique are illustrated in accordance with aspects of the present subject matter. Specifically, FIG. 1 illustrates a schematic, partial cross-sectional view of one embodiment of various components configured for use within the disclosed system 100 in accordance with aspects of the present subject matter and FIG. 2 illustrates a zoomed-in view of a portion of the system components shown in FIG. 1. Additionally, FIG. 3 illustrates a side view of several of the system components shown in FIG. 1.

In general, the disclosed system 100 may be configured to utilize powder-based additive manufacturing techniques (e.g., powder bed fusion techniques or other powder-based techniques) to manufacture or build a three-dimensional (3D) object in a cylindrical coordinate system (r, φ, z) relative to a substrate 102. For instance, as will be described below, the substrate 102 may be provided in operative association with a powder source 114 to allow a layer of powder material 116 to be deposited thereon as the substrate 102 is rotated relative to the power source. A suitable powder fusion/binder source 160 may then be used to selectively fuse or adhere the powder material together to allow the desired 3D object to be formed relative to the substrate 102 in accordance with an associated model (e.g., a 3D graphical computer model specifying the shape, dimensions, geometry, etc. of the 3D object).

In accordance with aspects of the present subject matter, the substrate 102 corresponds to a cylindrically-shaped member, such as a hollow or solid shaft or spindle, that is configured to be rotated about a rotational axis 104. As a result, the desired 3D object can be built-up radially in layers of selectively fused/adhered powder material relative to an outer cylindrical surface 106 of the substrate 102. For instance, as particularly shown in the zoomed-in view of FIG. 2, a cylindrical coordinate system may be defined relative to the rotational axis 104 of the substrate 102, with the r-coordinate corresponding to a distance defined relative to the rotational axis 104 in a radial direction (indicated by arrow R) of the substrate 102, the y-coordinate corresponding to an angle in a circumferential direction (indicated by arrow C) of the substrate 104 centered about the rotational axis 104, and the z-coordinate corresponding to a position along the rotational axis 104 in an axial direction (indicated by arrow A in FIG. 3) of the substrate 102 extending parallel to the axis 102. In this regard, by rotating the substrate 102 in the circumferential direction C and by actuating the substrate 102 in the axial direction A (either simultaneously or separately), the 3D object may be built-up via the selectively fused/adhered powder material in radial layers (e.g., with the r-coordinate being constant for each radial layer) relative to the outer circumferential surface 106 of the substrate 102 along the axial length of the substrate 102. The fusing process selectively solidifies powder in an extruded layer and according to a CAD model. Once a given radial layer of the 3D object is completed (e.g., along both the circumferential direction C and the axial direction A), the next radial layer of the 3D object (e.g., at an r-coordinate equal to the r-coordinate of the previous radial layer plus a given incremental value in the radial direction R corresponding to the layer thickness) may then be built-up on top of the previous radial layer. This process may be repeated until the desired form of the 3D object has been built-up relative to the outer cylindrical surface 106 of the substrate 102.

It should be appreciated that, using the disclosed system, a 3D object may be manufactured that defines any suitable profile or shape, including non-cylindrical shapes/profiles (e.g., arbitrary shapes/profiles) and other complex shapes/profiles according to a CAD model. For instance, FIGS. 2 and 3 illustrate an exemplary 3D profile (indicated by phantom line(s) 103) that can be achieved using the concepts disclosed herein. Additionally, it should be appreciated that, in one embodiment, the substrate 102 may be configured to form part of the final 3D object and, thus, may remain in place following completion of the manufacturing process. Alternatively, the substrate 102 may be removed following completion of the manufacturing process.

As will be described in greater detail below, the substrate 102 may be configured to be both rotated in the circumferential direction C and actuated in the axial direction A to allow the 3D object to be built up relative thereto y computer numerical control which follows the CAD model of part design. As such, the system 100 may include one or more substrate drives 108, 110 for rotating/actuating the substrate 102 as desired. For instance, as particularly shown in FIG. 3, the system 100 may include a rotational drive 108 (e.g., a motor) configured to rotate the substrate 102 in the circumferential direction C about its rotational axis 104. Additionally, as shown in FIG. 3, the system 100 may include an axial drive 110 (e.g., a lead or ball screw with scale, bearings and motor, a linear actuator, track drive, etc.) configured to actuate the substrate 102 in the axial direction A. It should be appreciated that, although the rotational and axial drives 108, 110 are shown as separate components, such drives 108, 110 may, instead, be incorporated into a single drive assembly for rotating/actuating the substrate 102.

As indicated above, the cylindrical substrate 102 may be provided in operative association with a powder source 114 containing a powder material 116. For instance, as particularly shown in FIG. 1, the substrate 102 may be configured to at least partially extend through a powder tank 114A containing a powder material 116 such that the outer surface 106 of the substrate 102 (or an outer surface 112 (FIG. 2) of the previous radial layer of the 3D object being formed relative to the substrate 102) contacts the powder material as the substrate 102 is rotated about its rotational axis 104 relative to the powder tank 114A.

In several embodiments, the powder tank 114A is generally configured as walled container or enclosure. For instance, as shown in FIGS. 1 and 3, the powder tank 114A includes a bottom wall 118, a front wall 120, a rear wall 122, and sidewalls 124, 126 (see FIG. 3) extending between the front and rear walls 120, 122 to create a container for holding the powder material 116. In one embodiment, the rear wall 122 and portions of the sidewalls 124, 126 may be taller than the front wall 120 to allow more powder material 116 to be contained within a rear portion 128 of the powder tank 114A (i.e., the portion of the tank 114A extending between the substrate and the rear wall 122). For instance, in one embodiment, the rear portion 128 of the powder tank 114A may be configured to accommodate powder material 116 at a vertical height 130 (FIG. 1) within the tank 114A (e.g., relative to the bottom wall 118 of the tank 114A) that exceeds a vertical height 132 (FIG. 1) of the substrate 102. As will be described below, such a heightened level of the powder material 116 within the tank 114A may allow for a layer 117 (FIG. 2) of powder material to be deposited onto the substrate 102 (or the previous radial layer of the 3D object being formed thereon) as the substrate 102 is rotated about its rotational axis 104 relative to the tank 114A.

Additionally, as shown in FIG. 1, the system 100 may also include a powder feed source 134 (e.g., a powder nozzle, conduit, and/or the like) for supplying powder material 116 into the tank 114A. In one embodiment, the powder feed source 134 may be automatically controlled (e.g., via a suitable computing system) to supply powder material 116 into the tank 114A so as to maintain a desired level of powder material therein (e.g., a level exceeding the height 132 of the substrate 102). Alternatively, the powder feed source 134 may be configured to be manually controlled.

It should be appreciated that the powder material 116 described herein may generally correspond to any suitable powder material. For instance, suitable powder materials may include, but are not limited to, metallic powder, such as stainless steel, titanium alloys, and nickel alloys, and ceramic powder, such as alumina, zirconia, silicon nitride.

As shown in FIGS. 1-3, the system 100 may also include a powder gate 136 configured to regulate the flow of powder material 116 from the rear portion 128 of the powder tank 114A. Specifically, the powder gate 136 may be movable relative to the substrate 102 in the radial direction R to regulate a thickness 138 (FIG. 2) of the layer 117 of powder material deposited relative to the outer surface 106 of the substrate 102 as the substrate 102 is rotated relative to both the powder source 114 and the gate 136. In several embodiments, the powder gate 136 may be coupled to a gate controller or actuator 140 (e.g., a linear actuator, such as a solenoid-activated actuator, a hydraulic actuator, or a pneumatic actuator, a lead or ball screw with a scale, bearings and a motor, etc.) that is configured to move the powder gate 136 relative to the substrate 102, thereby controlling the thickness 138 of the layer 117 of powder material. For instance, as particularly shown in FIG. 2, the gate actuator 140 may be configured to control the position of the powder gate 136 such that a radial gap 142 is defined between a distal end 136A of the gate 136 and the outer surface 106 of the substrate 102 (or the outer surface 112 of the radial layer of the 3D object previously formed relative to the substrate 102). In such an embodiment, the radial distance across the gap 142 may be selected such that a layer 117 of powder material having a desired thickness 138 is extruded or otherwise flows between the distal end 136A of the powder gate 136 and the outer surface 106 of the substrate 102 (or the outer surface 112 of the radial layer of the 3D object previously formed relative to the substrate 102) as the substrate 102 is rotated relative to both the powder tank 114A and the gate 136.

As shown in FIG. 2, an outer surface 144 of the powder gate 136 is generally aligned with the rotational axis 104 of the substrate 102 along a vertical plane such that the layer 117 of powder material extruded between the distal end 136A of the powder gate 136 and the outer surface 106 of the substrate 102 (or the outer surface 112 of the radial layer of the 3D object previously formed relative to the substrate 102) is generally positioned along the top side of the substrate 102, thereby allowing the powder material 116 to be fused/adhered together (e.g., via the fusion/binder source 160) prior to the powder material falling off due to gravity as the substrate 102 is rotated. For instance, as will be described below, the fusion/binder source 160 may be configured to direct an energy beam or flow of binder material towards a target zone 162 positioned immediately downstream of the gap 142 defined between the substrate 102 and the powder gate 136 to allow fusing/adhering of the material 116 at such location. Additionally, as shown in FIG. 3, in one embodiment, a side seal (e.g., first and second side seals 146) may be provided between the powder gate 136 and each sidewall 124, 126 of the tank 114A to prevent leakage or spillage of the powder material 116 from the tank 114A along the sides of the gate 136. As a result, the gap 142 defined between the distal end 136A of the powder gate 136 and the outer surface 106 of the substrate 102 (or the outer surface 112 of the radial layer of the 3D object previously formed relative to the substrate 102) generally provides the only location at which the powder material 116 is configured to be released from the powder tank 144A for deposition relative to the substrate 102.

Moreover, as shown in FIG. 1, a lower tank cover 148 may be provided along a front portion 150 of the powder tank 114A (i.e., the portion of the tank 114A extending between the substrate 102 and the front wall 120) to maintain the powder material 116 within the tank 114A, particularly given the difference in the fill level between the rear and front portions 128, 150 of the tank 114A. In one embodiment, the lower tank cover 148 may be movable relative to the substrate 102 (e.g., in the radial direction R) to allow a distal end 148A (FIG. 2) of the cover 148 to be positioned adjacent to the outer surface 106 of the substrate 102 (or the outer surface 112 of the radial layer of the 3D object previously formed relative to the substrate 102) as the substrate 102 is rotated relative to the cover 148. For instance, in the illustrated embodiment shown in FIG. 1, the lower tank cover 148 corresponds to a spring-loaded component that is configured to follow the profile of the 3D object being built-up relative to the substrate 102 as the substrate 102 is rotated past the cover 148. In another embodiment, the position of the lower tank cover 148 may be electronically controlled using a suitable actuator (e.g., a linear actuator, such as a solenoid-activated actuator, a hydraulic actuator, or a pneumatic actuator). For instance, the actuator may be actively controlled (e.g., using a suitable computing system) based on the computer model being used to build the 3D object such that the distal end 148A of the cover 148 is maintained directly adjacent to the outer surface 112 of such object as it being built-up radially relative the outer surface 106 of the substrate 102.

As indicated above, the disclosed system 100 may also include a suitable powder fusion/binder source 160 that can be actively controlled to allow the powder material 116 to be selectively fused or adhered together to build-up the desired 3D object relative to the substrate 102. In this regard, the powder fusion/binder source 160 may generally correspond to any suitable component that allows for the layer 117 of powder material deposited relative to the substrate 102 to be fused or adhered together. For instance, in the illustrated embodiment, the powder fusion/binder source 160 corresponds to a beam generating device 164 configured to direct an energy beam 166 (e.g., a laser beam, a beam of UV light, an electron beam, etc.) towards the layer 117 of powder material to selectively melt and fuse the powder material 116 together. As shown in FIG. 1, in one embodiment, the energy beam 166 may be initially transmitted from the beam generating device 164 towards an optical element 168 (e.g., one or more mirrors, lenses, etc.) prior to being directed towards the layer 117 of powder material deposited relative to the substrate 102. In one embodiment, two mirrors (only one 168 is shown), driven by a motor, rotate according to a numerical control program to direct the beam scanning on the layer surface 117. One rotating mirror generates a line scanning; two mirrors in coordination generate an area scanning. Alternatively, the energy beam 166 may be transmitted directly from the beam generating device 164 towards the layer 117 of powder material deposited relative to the substrate 102. In another embodiment, the powder fusion/binder source 160 may correspond to a binder distribution device configured to direct a flow of binder material (e.g., a liquid binding agent, such as an adhesive) towards the layer 17 of powder material to selectively adhere the powder material 116 together.

As particularly shown in FIG. 2, the fusion/binder source 160 may, in several embodiments, be configured to direct its energy beam or binder jet towards a target zone 162 positioned immediately downstream of the location at which the layer 117 of powder material passes between the powder gate 136 and the substrate 102. As such, the powder material 116 may be fused or adhered together at the rotational apex of the substrate 102, thereby preventing the powder material 116 from falling off due to gravity prior to fusion/binding.

As will be described in greater detail below, the operation of the fusion/binder source 160 may be actively controlled such that the powder material 116 deposited relative to the substrate 102 is selectively fused or adhered together at the target zone 162 in accordance with a computer model defining the desired shape, dimensions, geometry, etc. of the 3D object being built. For instance, when the computer model indicates that structure needs to be built-up across the layer 117 of powder material currently passing through the target zone 162, the fusion/binder source 160 may be activated (or otherwise not deactivated) to ensure that such powder material 116 is fused or adhered together to build-up such structure relative to the substrate 102. Alternatively, when the computer model indicates that no structure needs to be built-up across the layer 117 of powder material currently passing through the target zone 162, the fusion/binder source 160 may be deactivated (or otherwise not activated) to ensure that such powder material 116 is not fused or adhered together and can fall back into the tank 114A as the substrate 102 is further rotated away from the target zone 162.

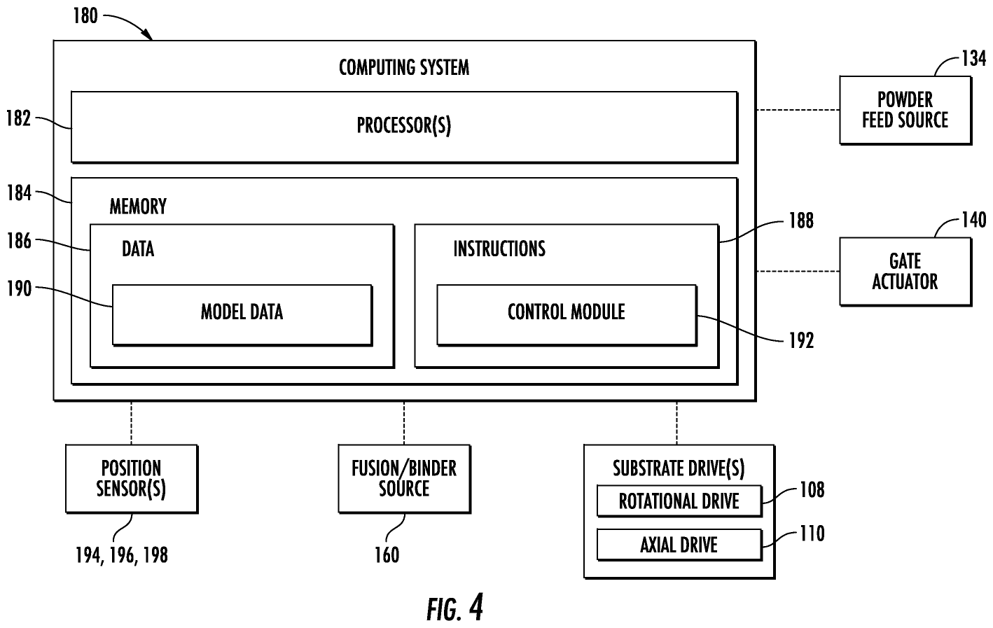

Referring to FIG. 4, a schematic view of one embodiment of a computing system 180 that may be used within the disclosed system 100 is illustrated in accordance with aspects of the present subject matter. In general, the computing system 180 may be configured to provide computing functionality to facilitate the manufacturing or building of a desired 3D object relative to a cylindrical substrate (e.g., substrate 102(. For instance, as will be described below, a computer model (e.g., a 3D graphical model) may be stored within the memory of the computing system 180 that specifies that dimensions, geometry, shape, etc. of the 3D object to be built. Based on such model, the computing system 180 may actively control various components of the disclosed system 100 (e.g., the fusion/binder source 160, the gate actuator 140, the substrate drives 108, 110, etc.) to build-up the 3D object relative to the substrate 102 in accordance with the model.

It should be appreciated that the computing system 180 may correspond to any suitable processor-based device(s), such as a computing device or any combination of computing devices. Thus, as shown in FIG. 4, the computing system 180 may generally include one or more processor(s) 182 and associated memory devices 184 configured to perform a variety of computer-implemented functions (e.g., performing the methods, steps, algorithms, calculations and the like disclosed herein). As used herein, the term “processor” refers not only to integrated circuits referred to in the art as being included in a computer, but also refers to a controller, a microcontroller, a microcomputer, a programmable logic controller (PLC), an application specific integrated circuit, and any other programmable circuits. Additionally, the memory 184 may generally comprise memory element(s) including, but not limited to, computer readable medium (e.g., random access memory (RAM)), computer readable non-volatile medium (e.g., a flash memory), a floppy disk, a compact disc-read only memory (CD-ROM), a magneto-optical disk (MOD), a digital versatile disc (DVD) and/or other suitable memory elements. Such memory 184 may generally be configured to store information accessible to the processor(s) 182, including data 186 that can be retrieved, manipulated, created and/or stored by the processor(s) 182 and instructions 188 that can be executed by the processor(s) 182.

In several embodiments, the data 186 may be stored in one or more databases. For example, the memory 184 may include a model database 190 for storing the graphical model(s) associated with the desired 3D object being built. For instance, the model(s) may correspond to one or more 3D computer-aided design (CAD) models that specify the shape, dimensions, geometry, etc. of the 3D object to be built. Such model(s) may also incorporate, for example, the size/dimensions of the substrate 102 (e.g., the outer diameter and axial length of the substrate 102) to allow the structure of the 3D object to be built-up in the cylindrical coordinate system relative to the substrate 102. For instance, the model(s) may define the structure of the 3D object in cylindrical coordinates (r, φ, z) taking into account the outer diameter of the cylindrical substrate 102, such as by defining the outer surface 106 of the substrate 102 as having an r-coordinate in the radial direction R of zero so that the r-coordinates of the 3D object start from zero and increase therefrom as the object is built-up radially outwardly from the outer surface 106 of the substrate 102.

Moreover, in several embodiments, the instructions 188 stored within the memory 184 of the computing system 180 may be executed by the processor(s) 182 to implement a control module 192. In general, the control module 192 may be configured to control the operation of the various system components to allow the desired 3D object to be built-up relative to the cylindrical substrate 102 per the specification of the associated model. For instance, in several embodiments, the control module 192 may be configured to control the operation of the fusion/binder source 160, the substrate drive(s) (e.g., the rotational drive 108 and/or the axial drive 110), the gate actuator 140, and/or any other suitable system components to facilitate building the desired 3D object.

In this regard, the computing system 180 may be communicatively coupled to one or more sensors that provide feedback for actively controlling one or more of the various components of the disclosed system 100. In several embodiments, the computing system 180 may be communicatively coupled to one or more substrate position sensors configured to provide an indication of the circumferential and/or axial position of the substrate 102 relative to a given reference location. For instance, referring briefly back to FIG. 3, in one embodiment, the computing system 180 may be communicatively coupled to both a circumferential position sensor 194 (e.g., a rotary encoder) and an axial position sensor 196 (e.g., a linear encoder), with the sensors 194, 196 providing data associated with the circumferential orientation and axial position, respectively, of the substrate 102. Specifically, the circumferential position sensor 194 may allow the computing system 180 to monitor the degree to which the substrate 102 has been rotated via the rotational driver 108, which may then allow the computing system 180 to determine the specific circumferential orientation or position of the substrate 102 and, thus, which circumferential section of the substrate 102 (and the object being built thereon) is currently passing through the target zone 162 of the fusion/binder source 160 (e.g., by determining the y-coordinate of the circumferential section the substrate/object passing through the target zone 162). Similarly, the axial position sensor 196 may allow the computing system 180 to monitor the axial position of the substrate 102 (e.g., as the substrate 102 is being actuated via the axial driver 110), which may then allow the computing system 180 to determine which axial section of the substrate 102 (and object being built-thereon) is currently passing through the target zone 162 of the fusion/binder source 160. It should be appreciated that, in other embodiments, the computing system 180 may also be communicatively coupled to one or more additional position sensors. For instance, referring again to FIG. 3, in one embodiment, a gate position sensor 198 may be provided (e.g., in association with the gate actuator 140) that allows the computing system 180 to actively monitor the position of the powder gate 136 (e.g., in the radial direction R relative to the substrate 102).

By continuously monitoring the circumferential and axial position of the substrate 102 based on the data received from the substrate-related position sensors 194, 196, the computing system 180 may be configured to accurately control the rotational and axial displacement of the substrate 102 (e.g., via controlling the operation of the respective substrate drives 108, 110). Additionally, the computing system 180 may actively control the operation of the fusion/binder source 160 (e.g., to selectively activate/deactivate the beam generating device 164 or the binder jetting device) by comparing the current circumferential/axial position of the substrate 102 to the graphical model associated with the 3D object. Specifically, as indicated above, the 3D object may be configured to be built-up relative to the substrate 102 in radial layers of a given thickness. As such, the computing system 180 may reference the graphical model to determine each axial/circumferential location (e.g., each pair of circumferential/axial coordinates (φ, z)) along a given radial layer (e.g., at a constant r-coordinate) at which a solid form or structure is present within the model versus each axial/circumferential location along such radial layer at which an open space is present. Thereafter, by knowing the exact circumferential and axial position of the substrate 102 relative to a given reference location (e.g., the target zone 162 of the fusion/binder source 160) based on the data from the position sensors 194, 196, the computing system 180 may selectively control the operation of the fusion/binder source 160 to build-up the desired 3D object relative to the substrate 102, such as by deactivating the fusion/binder source 160 when a portion of the 3D object being built that corresponds to an open space in the model passes through the target 162 and by maintaining the fusion/binder source 160 activated when a portion of the 3D object being built that corresponds to a solid form or structure in the model passes through the target zone 162.

It should be appreciated that, when building up the 3D object in radial layers, the substrate 102 may, in several embodiments, be actuated end-to-end as each layer is being created. For instance, referring briefly back to FIG. 3, the substrate 102 may be initially positioned relative to the powder tank 114A such that a first axial end 102A of the substrate 102 is positioned within the powder tank 114A. Thereafter, as the substrate 1-2 is being rotated and the 3D object is being built-up across such radial layer (e.g., via control of the fusion/binder source 160), the substrate 102 can be actuated axially (either continuously or incrementally) relative to the powder tank 114A (e.g., from left-to-right relative to the view shown in FIG. 3). For instance, in one embodiment, the substrate 102 can be actuated axially simultaneously with the substrate 102 being rotated about its axis to allow the 3D object to be built-up along a helical path. Alternatively, the substrate 102 may be rotated one full revolution prior to being actuated axially. Once the substrate 102 has been actuated fully end-to-end (e.g., such that an opposed second axial end 102B of the substrate 102 is positioned within the powder tank 114A) and the current radial layer of the 3D object has been completed, the powder gate 136 may be actuated radially outwardly relative to the substrate 102 by a given radial increment (e.g., a radial increment equal to the layer thickness 138) to allow the next radial layer to be built on top of the previous layer. The substrate 102 may then be actuated axially (either continuously or incrementally) relative to the powder tank 114A in the opposite direction (e.g., from right-to-left relative to view shown in FIG. 3) as the substrate 102 is being rotated and as the fusion/binder source 160 is being controlled per the specifications of the model to create the next radial layer. This back-and-forth axial motion can be repeated until the last radial layer has been built and the 3D object is complete.

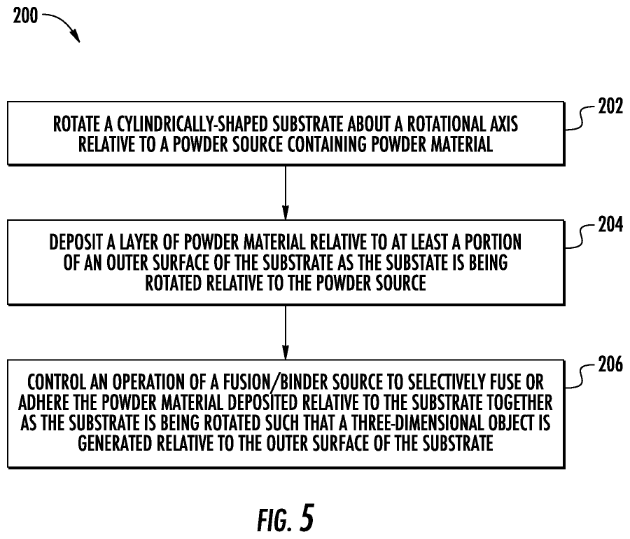

Referring now to FIG. 5, a flow diagram of one embodiment of a method 200 for building three-dimensional objects is illustrated in accordance with aspects of the present subject matter. In general, the method 200 will be described herein with reference to the embodiments of the system 100 described above with reference to FIGS. 1-4. However, it should be appreciated by those of ordinary skill in the art that the disclosed method 200 may generally be utilized in association with systems having any other suitable system configuration. In addition, although FIG. 5 depicts steps performed in a particular order for purposes of illustration and discussion, the methods discussed herein are not limited to any particular order or arrangement. One skilled in the art, using the disclosures provided herein, will appreciate that various steps of the methods disclosed herein can be omitted, rearranged, combined, and/or adapted in various ways without deviating from the scope of the present disclosure.

As shown in FIG. 5, at (202), the method 200 may include rotating a cylindrically-shaped substrate about a rotational axis relative to a powder source containing powder material. For instance, as indicated above, the computing system 180 may be communicatively coupled to a rotational driver 108 configured to rotationally drive the substrate 102 relative to a powder source, such as a powder tank 114A containing powder material 116.

Additionally, at (204), the method 200 may include depositing a layer of powder material relative to at least a portion of an outer surface of the substrate as the substrate is being rotated relative to the powder source. As described above, the movement of the powder gate 136 may be controlled to regulate the thickness of the layer 117 of powder material deposited relative to the outer surface 106 of the substrate 102. For instance, the powder gate 136 may be positioned relative to the substrate 102 such that a gap is defined between the gate 136 and the outer surface 106 of the substrate 102 (or the outer surface 112 of the object being built relative thereto). Thus, as the substrate 102 is rotated relative to both the powder source 114 and the powder gate 136, a layer 117 of powder material may be deposited relative to the substrate 102.

Moreover, at (206), the method 200 may include controlling an operation of a fusion/binder source to selectively fuse or adhere the powder material deposited relative to the substrate together as the substrate is being rotated such that a three-dimensional object is generated relative to the outer surface of the substrate. For instance, as indicated above, the computing system 180 may be configured to control the operation of the fusion/binder source 160 to selectively fuse/adhere the layer 117 of powder material positioned at the target zone 162 such that a 3D object is built relative to the substrate 102 in accordance with an associated 3D model accessible to the computing system 180.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims or if they include equivalent structural elements with insubstantial differences from the literal language of the claims.

1. A system for building three-dimensional objects, the system comprising:
a powder tank containing a powder material;
a cylindrically-shaped substrate rotatable about a rotational axis, the substrate extending axially through at least a portion of the powder tank such that rotation of the substrate relative to the powder tank about the rotational axis results in a layer of powder material being deposited relative to at least a portion of an outer surface of the substrate;
a fusion/binder source configured to cause the powder material deposited relative to the substrate to be fused or adhered together; and
a computing system configured to control an operation of the fission/binder source as the substrate is rotated about the rotational axis to generate a three-dimensional object relative to the outer surface of the substrate,
wherein, the substrate is positioned relative to the powder tank such that portions of the layer of powder material deposited relative to the substrate that are not fused or adhered together by the fusion/binder source are directed back into the powder tank with rotation of the substrate relative to the powder tank.

2. The system of claim 1, wherein a model associated with the three-dimensional object is accessible by the computing system and wherein the computing system is configured to selectively activate or deactivate the fission/binder source to generate the three-dimensional object in accordance with the model.

3. The system of claim 1, further comprising at least one position sensor configured to generate data associated with at least one of a circumferential position or an axial position of the substrate.

4. The system of claim 3, wherein a model associated with the three-dimensional object is accessible by the computing system and wherein the computing system is configured to selectively activate or deactivate the fission/binder source to generate the three-dimensional object in accordance with the model based at least in part on the data received from the at least one position sensor.

5. The system of claim 1, further comprising a powder gate movable relative to the outer surface of the substrate to regulate a thickness of the layer of powder material deposited relative to the at least a portion of the outer surface of the substrate as the substrate is rotated relative to both the powder tank and the powder gate.

6. The system of claim 5, further comprising a gate actuator configured to move the powder gate relative to the outer surface of the substrate.

7. The system of claim 6, wherein the computing system is configured to control an operation of the gate actuator to move the powder gate radially outwardly relative to the outer surface of the substrate as the three-dimensional object is built-up radially relative to the outer surface of the substrate.

8. The system of claim 1, wherein the three-dimensional object is built-up radially in layers relative to the outer surface of the substrate as the substrate is rotated about the rotational axis.

9. The system of claim 1, wherein the fusion/binder source is configured to cause the powder material to be fused or adhered together at a target zone aligned with an axial section of the substrate relative to which the layer of powder material has been deposited, the system further comprising a substrate drive configured to axially actuate the substrate relative to the target zone.

10. (canceled)

11. The system of claim 1, wherein the fusion/binder source comprises a beam generating device configured to direct an energy beam towards the layer of powder material to fuse the powder material together.

12. The system of claim 11, wherein the energy beam comprises a laser beam, a beam of UV light, or an electron beam.

13. A method for building a three-dimensional object, the method comprising:
rotating a cylindrically-shaped substrate about a rotational axis relative to a powder source containing powder material;
depositing a layer of powder material relative to at least a portion of an outer surface of the substrate as the substrate is being rotated relative to the powder source; and
controlling an operation of a fusion/binder source to selectively fuse or adhere the powder material deposited relative to the substrate together as the substrate is being rotated such that a three-dimensional object is generated relative to the outer surface of the substrate.

14. The method of claim 13, further comprising accessing, with a computing system, a model associated with the three-dimensional object and wherein controlling the operation of the fusion/binder source comprises selectively activating or deactivating, with the computing system, the fusion/binder source to generate the three-dimensional object in accordance with the model.

15. The method of claim 13, further comprising monitoring at least one of a circumferential position or an axial position of the substrate.

16. The method of claim 14, further comprising accessing, with a computing system, a model associated with the three-dimensional object and wherein controlling the operation of the fusion/binder source comprises selectively activating or deactivating, with the computing system, the fusion/binder source to generate the three-dimensional object in accordance with the model based at least in part on the data received from the at least one position sensor.

17. The method of claim 13, wherein depositing the layer of powder material comprises controlling movement of a powder gate positioned relative to the substrate to regulate a thickness of the layer of powder material deposited relative to the at least a portion of the outer surface of the substrate as the substrate is rotated relative to both the powder source and the powder gate.

18. The method of claim 16, further comprising controlling the movement of the powder gate to cause the powder gate to be moved radially outwardly relative to the outer surface of the substrate as the three-dimensional object is built-up radially relative to the outer surface of the substrate.

19. The method of claim 13, wherein controlling the operation of the fusion/binder source comprises controlling the operation of the fusion/binder source to cause the powder material to be fused or adhered together at a target zone aligned with an axial section of the substrate relative to the which the layer of powder material has been deposited, the method further comprising axially actuating the substrate to adjust which axial section of the substrate is aligned with the target zone.

20. The method of claim 13, wherein the fusion/binder source comprises a beam generating device and wherein controlling the operation of the fusion/binder source comprises controlling the operation of the beam generating device to direct an energy beam towards the layer of powder material to fuse the powder material together.
